(19) United States
(12) Patent Application Publication
(10) Pub. No.: US 2026/0261894 A1
(43) Pub. Date: Sep. 3, 2026

(54) METHODS, COMMUNICATIONS DEVICES, AND INFRASTRUCTURE EQUIPMENT

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/719,870

(22) PCT Filed: Dec. 6, 2022
(86) PCT No.: PCT/EP2022/084638

§ 371 Date: Jun. 14, 2024

(30) Foreign Application Priority Data
Dec. 23, 2021 (EP) 21217506.1

(51) Int. Cl. H04W 24/10; H04W 36/00; H04W 88/04

(52) U.S. Cl. CPC H04W 24/10; H04W 36/0058; H04W 88/04

(57) ABSTRACT

A method of operating a communications device acting as a relay node configured to transmit signals to and/or to receive signals from a wireless communications network and to transmit signals to and/or to receive signals from a plurality of remote communications devices is provided. The method comprises accumulating a plurality of measurement reports each indicating measurements of a communications channel between the relay communications device and one of the remote communications devices, generating an accumulated measurement report comprising indications of a selected one or more of the accumulated plurality of measurement reports, and transmitting, to the wireless communications network, the generated accumulated measurement report.

### BACKGROUND

### Field of Disclosure

The present disclosure relates generally to communications devices and infrastructure equipment operating in wireless communications networks, and specifically to handover procedures performed in such wireless communications networks.

The present application claims the Paris Convention priority from European patent application number EP 21217506.1 filed on 23 Dec. 2021, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Latest generation mobile telecommunication systems are able to support a wider range of services than simple voice and messaging services offered by earlier generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with an ever-increasing range of devices and data traffic profiles than existing systems are optimised to support. For example, it is expected future wireless communications networks will be expected to efficiently support communications with devices including reduced complexity devices, machine type communications devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for future wireless communications networks, for example those which may be referred to as 5G or new radio (NR) system/new radio access technology (RAT) systems [1], as well as future iterations/releases of existing systems, to efficiently support connectivity for a wide range of devices associated with different applications and different characteristic data traffic profiles. The connectivity of devices is conventionally maintained through the use of so-called “handover” procedures where a communications device changes its access point to a wireless communications network in response to an instruction from the wireless communications network or in response to one or more conditions being met. In view of the wide range device types and capabilities in future wireless communications networks, there is a need for improved handover procedures.

### SUMMARY OF THE DISCLOSURE

The present disclosure can help address or mitigate at least some of the issues discussed above.

Embodiments of the present technique can provide a method of operating a communications device acting as a relay node configured to transmit signals to and/or to receive signals from a wireless communications network and to transmit signals to and/or to receive signals from a plurality of remote communications devices. The method comprises accumulating a plurality of measurement reports each indicating measurements of a communications channel between the relay communications device and one of the remote communications devices, generating an accumulated measurement report comprising indications of a selected one or more of the accumulated plurality of measurement reports, and transmitting, to the wireless communications network, the generated accumulated measurement report

Embodiments of the present technique, which in addition to methods of operating communications devices, also relate to communications devices, infrastructure equipment, methods of operating infrastructure equipment, and circuitry for communications devices and infrastructure equipment, allow for the more efficient performance of handovers by communications devices in wireless communications networks.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 schematically represents aspects of a conventional handover procedure;

FIG. 5 is reproduced from [4], and illustrates an example scenario for a group handover procedure;

FIG. 6 is reproduced from [4], and illustrates an example group handover command;

FIG. 7 is a part schematic representation, part message flow diagram of communications between a communications device and an infrastructure equipment forming part of a wireless communications network in accordance with embodiments of the present technique; and

FIG. 8 shows a flow diagram illustrating a process of communications in a communications system in accordance with embodiments of the present technique.

### DETAILED DESCRIPTION OF THE EMBODIMENTS

### Long Term Evolution Advanced Radio Access Technology (4G)

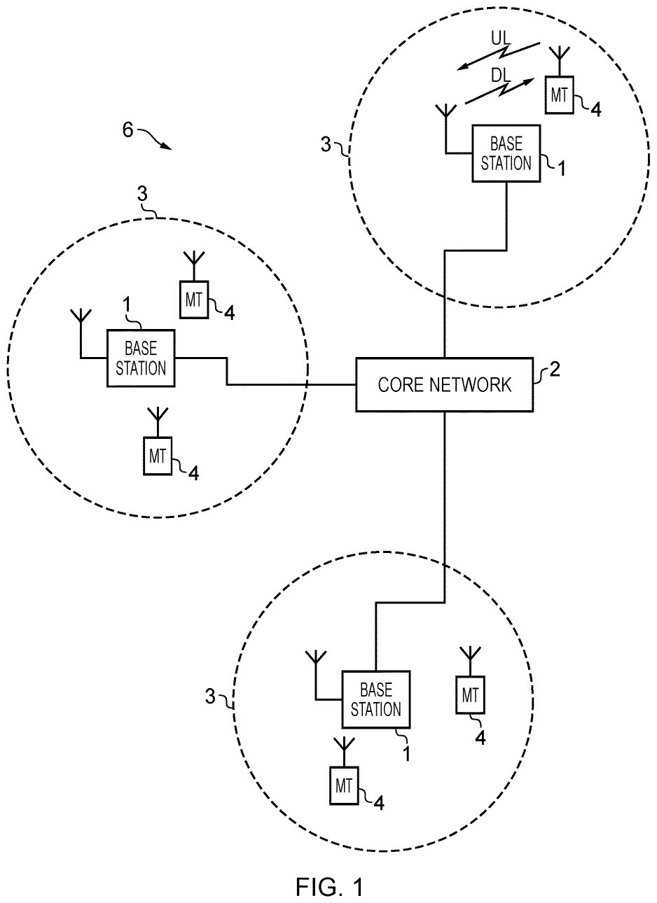

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network (RAN).

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

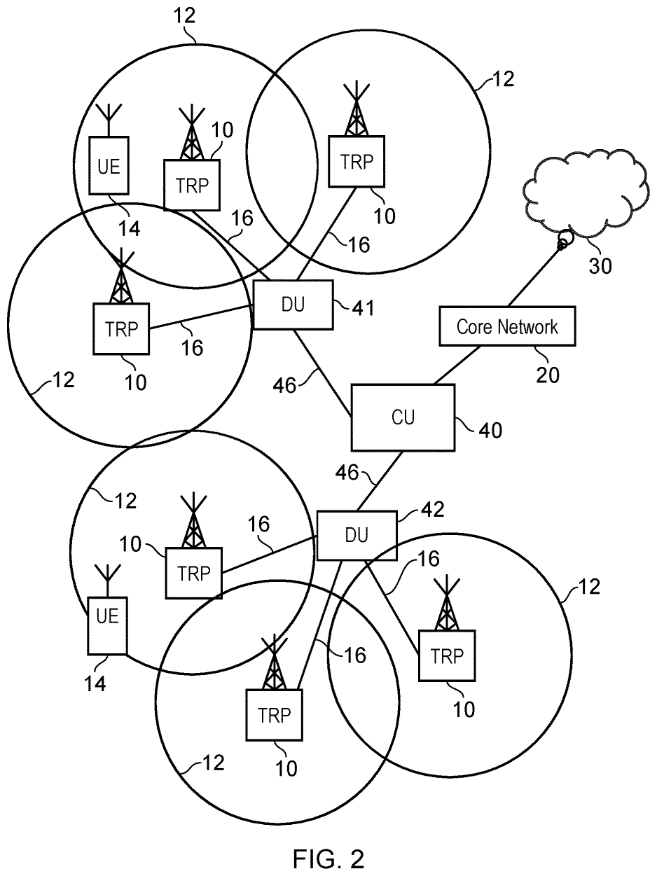

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

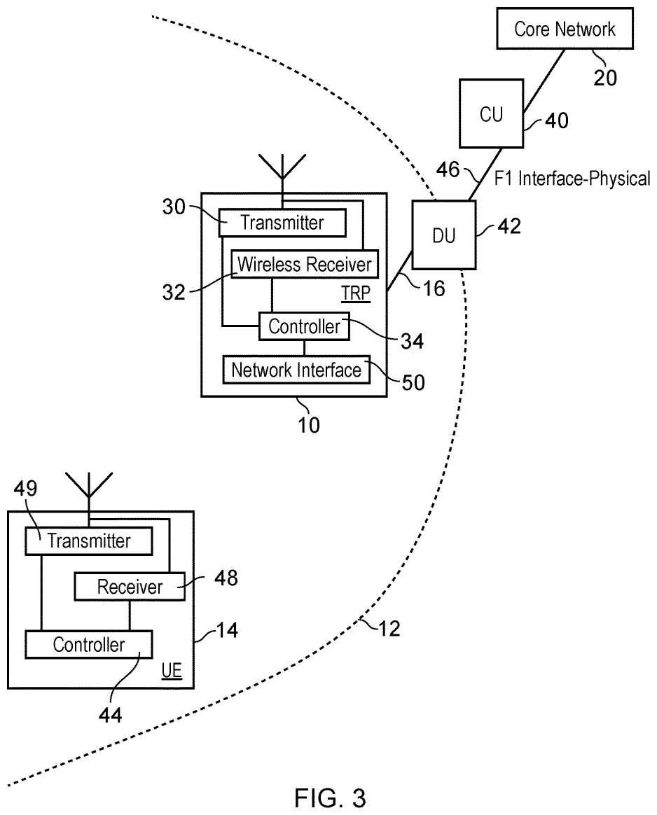

A more detailed diagram of some of the components of the network shown in FIG. 2 is provided by FIG. 3. In FIG. 3, a TRP 10 such as that shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

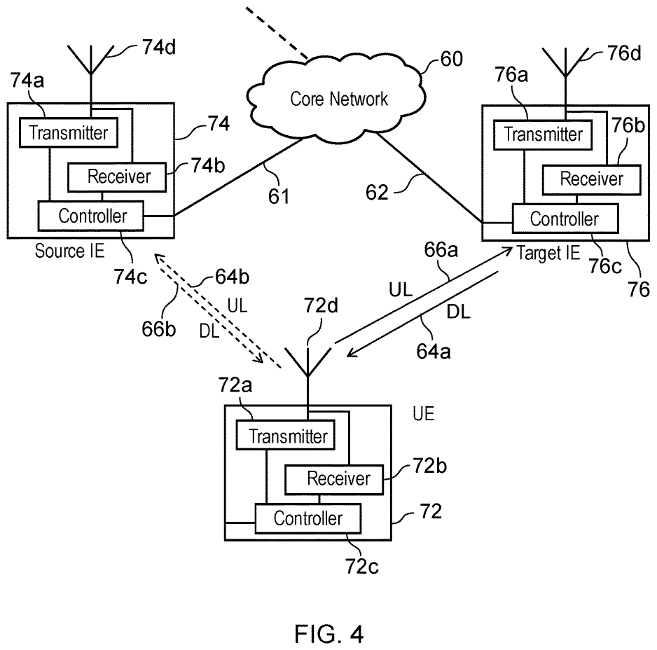

A detailed illustration of a wireless communications network in which a handover (HO) may be performed is shown in FIG. 4. As will be appreciated from FIG. 4, a communications device 72 is handed over from a source infrastructure equipment 74 to a target infrastructure equipment 76 forming part of a radio access network to a core network 60. As will be appreciated the communications device 72 is an example of a communications device such as the communications device 14 of FIGS. 1, 2 and 3. The communications device 72 may be a UE in one example.

Before the handover, the communications device 72 transmits signals on an uplink UL and receive signals on a downlink DL from a source infrastructure equipment 74. The source infrastructure equipment 74 and the target infrastructure equipment 76 may each be thought of as a gNB 1 as shown in FIG. 1 or a combination of a controlling node 40 and TRP 10 as shown in FIGS. 2 and 3. Before the handover, the communications device 72 is shown to transmit uplink data to the source infrastructure equipment 74 via uplink resources UL of a wireless access interface as illustrated generally by dashed arrow 64b to the source infrastructure equipment 74. The communications device 72 may similarly be configured to receive downlink data transmitted by the source infrastructure equipment 74 via downlink resources DL as indicated by dashed arrow 66b from the source infrastructure equipment 74 to the communications device 72. After the handover, the communications device 72 is shown to transmit uplink data to the target infrastructure equipment 76 via uplink resources UL of a wireless access interface as illustrated generally by solid arrow 66a to the target infrastructure equipment 76. The communications device 72 may similarly be configured to receive downlink data transmitted by the target infrastructure equipment 76 via downlink resources DL as indicated by solid arrow 64a from the target infrastructure equipment 76 to the communications device 72.

In FIG. 4, the source and target infrastructure equipment 74, 76 are each connected to a core network 60 via interfaces 61, 62 to a controller 74c, 76c of the respective infrastructure equipment 74. The source and target infrastructure equipment 74, 76 each include a receiver 74b, 76b connected to an antenna 74d, 76d and a transmitter 74a, 76a connected to the antenna 74d, 76d. Correspondingly, the communications device 72 includes a controller 72c connected to a receiver 72b which receives signals from an antenna 72d and a transmitter 72a also connected to the antenna 72d.

The controllers 74c, 76c are configured to control the source and target infrastructure equipment 74, 76 respectively and may comprise processor circuitry which may in turn comprise various sub-units/sub-circuits for providing functionality as explained further herein. These sub-units may be implemented as discrete hardware elements or as appropriately configured functions of the processor circuitry. Thus the controllers 74c, 76c may comprise circuitry which is suitably configured/programmed to provide the desired functionality using conventional programming/configuration techniques for equipment in wireless telecommunications systems. The transmitters 74a, 76a and the receivers 74b, 76b may comprise signal processing and radio frequency filters, amplifiers and circuitry in accordance with conventional arrangements. The transmitters 74a, 76a the receivers 74b, 76b and the controllers 74c, 76c are schematically shown in FIG. 4 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 74 will in general comprise various other elements associated with its operating functionality.

Correspondingly, the controller 72c of the communications device 72 is configured to control the transmitter 72a and the receiver 72b and may comprise processor circuitry which may in turn comprise various sub-units/sub-circuits for providing functionality as explained further herein. These sub-units may be implemented as discrete hardware elements or as appropriately configured functions of the processor circuitry. Thus the controller 72c may comprise circuitry which is suitably configured/programmed to provide the desired functionality using conventional programming/configuration techniques for equipment in wireless telecommunications systems. Likewise, the transmitter 72a and the receiver 72b may comprise signal processing and radio frequency filters, amplifiers and circuitry in accordance with conventional arrangements. The transmitters 72a, receivers 72b, and controllers 72c are schematically shown in FIG. 4 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 72 will in general comprise various other elements associated with its operating functionality, for example a power source, user interface, and so forth, but these are not shown in FIG. 4 in the interests of simplicity.

The controllers 74c, 72c may be configured to carry out instructions which are stored on a computer readable medium, such as a non-volatile memory. The processing steps described herein may be carried out by, for example, a microprocessor in conjunction with a random access memory, operating according to instructions stored on a computer readable medium.

### Sidelink Relay

As mentioned above, the introduction of a wide range of new device types and capabilities in NR creates technical challenges in maintaining device connectivity with a wireless communications network. One aspect of NR currently under development of the 3GPP group is that of the sidelink relay, which is discussed in 3GPP Release-17. For example, 3GPP study item [3] discusses a single-hop NR sidelink-based relay. In particular, [3] targets:
Study mechanism(s) with minimum specification impact to support Service and System Aspect (SA) requirements for sidelink-based UE-to-network and UE-to-UE relay, focusing on the following aspects (if applicable) for layer-3 relay and layer-2 relay [RAN2];
   Relay (re-)selection criterion and procedure;
   Relay/Remote UE authorization;
   QoS for relaying functionality;
   Service continuity;
   Security of relayed connection after SA3 has provided its conclusions; and
   Impact on user plane protocol stack and control plane procedure, e.g., connection management of relayed connection; and
Study mechanism(s) to support upper layer operations of discovery model/procedure for sidelink relaying, assuming no new physical layer channel/signal [RAN2].

It is noted in [3] that it is expected that UE-to-network relays and UE-to-UE relays will use the same relaying solution, and that forward compatibility for multi-hop relay support in future releases of standards should be taken into account. It is also noted in [3] that, for layer-2 UE-to-network relays, the architecture of end-to-end Packet Data Convergence Protocol (PDCP) and hop-by-hop Radio Link Control (RLC), as recommended in [4], is taken as a starting point.

During a 3GPP meeting (RAN2 #115e), it was initially agreed during an email discussion [5] that a relay UE should not be configured with measurements towards one particular remote UE for the purposes of path switch for that remote UE. That is, a relay UE, according to [5] was not to be configured with measurements towards remote UEs. However, during the email discussion, some interest was shown with respect to this proposal. It was subsequently agreed that once a relay UE is configured with measurements towards the remote UE, some additional enhancements relating to handover would be possible.

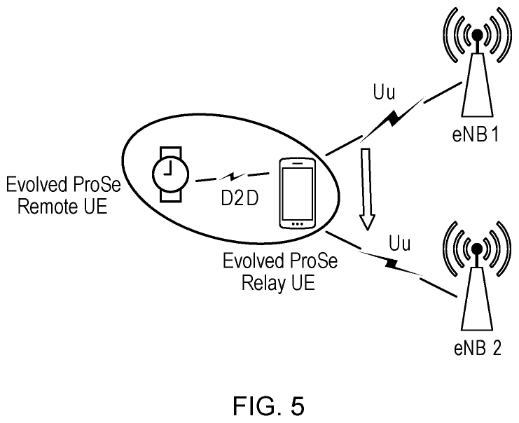

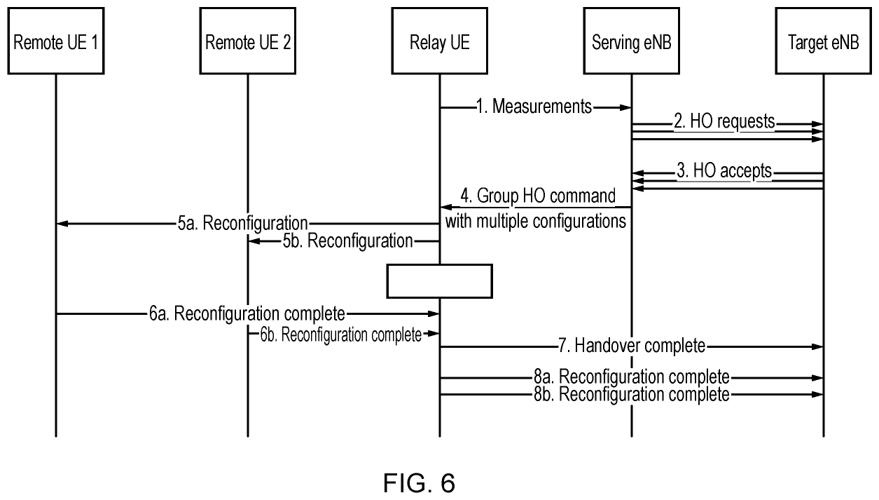

In Further Enhancement to Device-to-Device (FeD2D) networks, the group handover (GHO) scenario defines that the relay together with its remote UEs will perform handover, and so the group handover command is triggered by the relay UE's measurements (based on reference signals received from its serving base station) being indicated to the serving base station. This group handover scenario is named GHO scenario 1. A problem still exists with GHO scenario 1 relating to how the relay UE knows which of the remote UEs currently connected to it are going to move together with the relay UE, if not all of its remote UEs are going to move together with it. An example of a group handover in accordance with GHO scenario 1 is illustrated in FIGS. 5 and 6, both of which are reproduced from [4], within which a full description of FIGS. 5 and 6 is provided.

There is another possible group handover scenario where a group of remote UEs handover from one relay UE to another relay UE, and this group handover scenario is called GHO scenario 2. In this case, if the relay UE is not configured with any measurement to its remote UEs, then the legacy procedure will be as follows: the remote UE(s) performs measurement->sends these measurements to the serving base station via the relay UE->the base station sends the HO command to the remote UE(s) via the relay UE.

However, this procedure has drawbacks, including:
Each individual remote UE will send its own measurement report to the base station via the relay UE, and therefore this will incur signalling overheads on both the PC5 (between the remote and relay UEs) and Uu (between the relay UE and base station) links; and
When the network configures multiple HO configurations within one RRC message to a relay, and the relay then forwards the RRC message to each of its remote UEs, group handover may not be triggered, as the network will instead send individual HO commands to each individual remote UE based on that remote UE sending its own measurement report. Therefore, the benefits of group handover are missing.

In accordance with embodiments of the present technique, it is assumed that the relay UE may (in at least some embodiments) be configured with measurements towards remote UEs, and based on this assumption, some enhancements—especially relating to measurements and group handover procedures—are proposed.

### Measurement and Handover Enhancement in Sidelink Relay

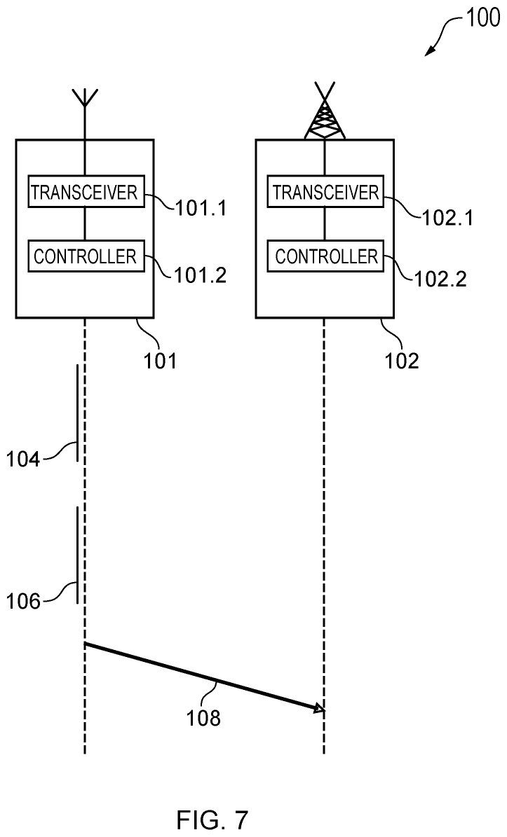

FIG. 7 provides a part schematic representation, part message flow diagram of communications within a wireless communications system 100 between a communications device or UE 101 which acts as a relay node and a wireless communications network in accordance with embodiments of the present technique. The wireless communications network may include an infrastructure equipment 102 which provides and controls a first cell having a coverage area within in one of which the relay communications device 101 may be located, or may enter in and out of. The relay communications device 101 comprises a transceiver (or transceiver circuitry) 101.1 configured to transmit signals to and/or receive signals from the wireless communications network (for example, to the infrastructure equipment 102 via a wireless access interface provided by the wireless communications network), or indeed from other wireless communications networks, as well as to transmit signals to and/or to receive signals from a plurality of remote communications devices, and a controller (or controller circuitry) 101.2 configured to control the transceiver circuitry 101.1 to transmit or to receive the signals. As can be seen in FIG. 7, the infrastructure equipment 102 may also comprise a transceiver (or transceiver circuitry) 102.1 which may be configured to transmit signals to and/or receive signals from the relay communications device 101 via the wireless access interface, and a controller (or controller circuitry) 102.2, which may be configured to control the transceiver circuitry 102.1 to transmit or to receive the signals. Each of the controllers 101.2, 102.2 may be, for example, a microprocessor, a CPU, or a dedicated chipset, etc.

The controller circuitry 101.2 of the relay communications device 101 is configured in combination with the transceiver circuitry 101.1 of the relay communications device 101 to accumulate 104 a plurality of measurement reports each indicating measurements of a communications channel between the relay communications device 101 and one of the remote communications devices, to generate 106 an accumulated measurement report comprising indications of a selected one or more of the accumulated plurality of measurement reports, and to transmit 108, to the wireless communications network (e.g. to the infrastructure equipment 102), the generated accumulated measurement report.

Essentially, embodiments of the present technique propose that an accumulated measurement report will be collected, generated, and transmitted from a relay UE to the network, rather than forwarding individual measurement reports each time one is received from remote UE or sending individual measurement reports generated by the relay UE based on measurements performed towards each remote UE, in order to help the network to perform an informed group handover with reduced signalling overheads. Furthermore, at least some embodiments of the present technique propose that if serving and target relay UEs are configured with measurements towards remote UEs, a potential candidate target relay UE (in accordance with GHO scenario 2 as described above) can initiate the handover procedure itself if it monitors a group of remote UEs/a single remote UE is moving towards it. With this procedure, the signalling overheads that rely on measurement report triggered handovers can be reduced.

With reference to FIG. 7, the selected one or more of the accumulated plurality of measurement reports may be selected by the relay communications device 101, for example, based on determining that the remote communications devices associated with the selected one or more of the accumulated plurality of measurement reports should perform a group handover with the relay communications device 102 from a first infrastructure equipment 101 of the wireless communications network to a second infrastructure equipment of the wireless communications network—i.e. in accordance with GHO scenario 1. Alternatively, the selected one or more of the accumulated plurality of measurement reports may be selected by the relay communications device 101, for example, based on determining that the remote communications devices associated with the selected one or more of the accumulated plurality of measurement reports should perform a group handover from the relay communications device 101 to another relay communications device—i.e. in accordance with GHO scenario 2. Effectively therefore, the relay communications device 101 will accumulate measurement reports associated with a plurality of remote communications devices (where such measurement reports may be produced either by the individual remote communications devices or by the relay communications device 101 individually for each remote communications device). The selected one or more of the accumulated plurality of measurement reports are then included within the generated accumulated measurement report based on those measurement reports being similar, for example, and the relay communications device 101 thus determining that handover should be performed either by itself and one or more of the remote communications devices between infrastructure equipment of the wireless communications network, or by a plurality of the remote communications devices between itself and another relay communications device—therefore essentially performing a filtering function on the measurement reports to include in the accumulated measurement report as well as transmitting the accumulated measurement report as a single report rather than as individual measurement reports. This therefore enables the reduction of signalling overheads in two ways, further improving the efficiency of measurement reporting and group handover performance.

In accordance with some arrangements of embodiments of the present technique, a relay UE may not be configured with measurements towards remote UEs; that is, the relay UE does not itself perform measurements and generate measurement reports on signals (e.g. reference signals or discovery messages) received from those remote UEs. In this case, remote UEs will send measurement reports to the relay UE, and the relay UE will generate an accumulated measurement report and send this to its serving gNB. In other words, the relay communications device may be configured to transmit reference signals/a discovery message to the remote communications devices, and to receive the measurement reports from the remote communications devices, the measurements indicated by the measurement reports having been performed by the remote communications devices on the transmitted reference signals/discovery message.

For GHO scenario 1, remote UEs which have similar measurement results to each other—and may also have relatively stable measurement results with respect to the relay UE—indicate that these remote UEs should handover with the relay UE from eNB1 to eNB2, and these measurement results will therefore be accumulated. For GHO scenario 2, remote UEs which have similar measurement results to one another and where such measurements indicate they are moving towards a certain relay UE will similarly be accumulated. Sending an accumulated measurement report instead of sending individual measurement reports for each of the remote UEs will provide benefits with respect to the reduction of control signalling overheads.

The accumulated measurement report may include one or more of the following information elements:
1) Remote UE ID-the local UE ID;
2) Number of remote UEs (i.e. that have similar measurements and thus (or are otherwise) have their measurements included within the accumulated measurement report);
3) Measurement results: the individual measurement results e.g. reference signal received power (RSRP), reference signal received quality (RSRQ), interference level, or Received Signal Strength Indicator (RSSI) of each of the remote UEs. The inclusion of the measurement results in the accumulated measurement report is optional if relay can itself decide which remote UEs will move together with it—e.g. for GHO scenario 1, the relay UE may receive a handover command from the network and independently decide which of its relay UEs should handover with it. Otherwise, this information should be sent to the network to assist the network in making any required handover decisions;
4) Triggered events (e.g. events A3/A5/A4 as defined in [6] for example and which would be well-understood by those skilled in the art); and
5) Target node (e.g. a target eNB/gNB in GHO scenario 1, or a target relay UE in GHO scenario 2). This target node indication may be implicit; for example, the measurement results (referred to under point 3) above) may be listed in order of strength, thus implicitly indicating a target node for GHO or one or more remote UEs which should form part of the GHO.

In other words, the accumulated measurement report may comprise indications of one or more of: identifiers associated with each of the remote communications devices associated with the selected one or more of the accumulated plurality of measurement reports, the number of remote communications devices associated with the selected one or more of the accumulated plurality of measurement reports, the measurements of each of the selected one or more of the accumulated plurality of measurement reports, and one or more events that have been triggered on the basis of the measurements.

Where at least some of the individual measurement results are not included in the accumulated reports, the amount of transmitted information can accordingly be reduced. For the at least some of the individual results which are included in the accumulated reports, the amount of time required for transmission of them by the relay UE is reduced; e.g. without using an accumulated report, the relay UE would otherwise need to forward each individual report whenever one is received from remote UEs. On the other hand, with an accumulated report, the relay UE only needs to transmit one such report. This reduces the required access signalling from the relay UE. This may also reduce power consumption at the relay UE as the relay UE transmits the accumulated report in one go/one message, instead of transmitting each message separately at different times.

It is not expected that all of the remote UEs will send measurement reports at the same time, so a measurement report reception window (i.e., time period) may be configured for the relay UE, to know when to generate and transmit an accumulated measurement report, and which individual remote UE measurement reports should be included within this accumulated measurement report. In other words, the selected one or more of the accumulated plurality of measurements reports are those received from the remote communications devices during a predetermined period.

The relay UE will collect the measurement reports received during this period, and may send an accumulated report only on the condition that the number of received reports is above a pre-defined threshold. In other words, the relay communications device is configured to transmit the generated accumulated measurement report to the wireless communications network only if the number of the selected one or more of the accumulated plurality of measurements reports received from the remote communications devices during the predetermined period is above a predefined threshold number.

The reception window can be triggered (i.e. initiated) after the relay UE receives a first measurement report from any remote UE (i.e. a first measurement report since the last received measurement report that was included in the most recently transmitted accumulated measurement report). Those skilled in the art would appreciate that this threshold can be set to one, which means that no matter how many reports are received during the window of time, an accumulated report will still be sent. In the case that the threshold is bigger than one, if the received number of reports during the window is less than the threshold, then only individual reports will be forwarded.

In accordance with some arrangements of embodiments of the present technique, a relay UE may be configured with measurements towards remote UEs; that is, the relay UE performs measurements and generates measurement reports on signals (e.g. reference signals) received from those remote UEs. The relay UE will then generate an accumulated measurement report including one or more of these generated measurement reports, and will send this accumulated measurement report to its serving gNB. In other words, the relay communications device may be configured to receive reference signals from the remote communications devices, and to perform the measurements on the received reference signals to generate the plurality of measurement reports.

For GHO scenario 1, the relay UE/gNB needs to identify which remote UEs are going to stay with the relay UE on handover between gNBs (and which remote UEs are not). If the relay UE is configured with measurements towards remote UEs and reference signals received from remote UEs can be associated with a specific remote UE (e.g. the reference signals are scrambled with a local remote UE ID), then the relay UE can identify the remote UEs which are going to stay with it by, for example, determining that they have a stable RSRP value or a stable relative distance with respect to the relay UE, etc. Then an accumulated measurement report will be sent by the relay UE to the gNB. In other words, each of the received reference signals comprises an indication of an identifier associated with the remote communications device from which it was received.

For GHO scenario 2, the potential target relay UE needs to identify which remote UEs are going to switch to it. In other words, the relay communications device may be configured to transmit, to another relay communications device via an infrastructure equipment of the wireless communications network, an indication of identifiers associated with the remote communications devices associated with the selected one or more of the accumulated measurement reports, the other relay device being a target for a group handover to be performed by the remote communications devices associated with the selected one or more of the accumulated measurement reports from the relay communications device to the other relay communications device. More generally, in accordance with some arrangements of embodiments of the present technique, ID sharing may not be on the basis of (or associated with) the accumulated measurement report at all—in other words, the relay communications device may be configured to transmit, to another relay communications device via an infrastructure equipment of the wireless communications network, an indication of identifiers associated with one or more of the plurality of remote communications devices.

The other (target) relay communications device may be within a same cell (intra-cell) of the wireless communications network as the relay communications device, or the other (target) relay communications device may be within a different cell (inter-cell) of the wireless communications network to the relay communications device. In the intra-cell case, all the relay UEs in the cell can be configured with measurements towards any remote UEs. The local remote UE IDs can then be shared between relays, while it is up to the gNB's implementation to guarantee that there will be no collisions of local remote UE IDs among relays. In the inter-cell case, there will be inter-cell exchange signalling to exchange the local remote UEs ID, in order to allow the relay UEs who are across different cells to be able to identify specific remote UEs.

Enhanced group handover procedures as described herein are applicable to both GHO scenario 1 and GHO scenario 2. Here, in arrangements described below, it is assumed that the relay UE is configured with measurements towards remote UEs. The enhanced group handover procedures described below may be initiated, in accordance with different arrangements of embodiments of the present disclosure, by either the source relay UE or (in the case of GHO scenario 2) by the target relay UE.

In arrangements of embodiments of the present technique where the group handover procedure is initiated by the source relay UE (either for GHO scenario 1 or GHO scenario 2), the source relay UE will perform the measurements towards the remote UEs, and obtain information relating to, for example, which remote UEs are going to stay with it as it hands over from one gNB to another (GHO scenario 1) or which of the remote UEs are going to switch to another relay UE (GHO scenario 2). Following this, the source relay UE will send an accumulated measurement report to the network which may include the remote UE information and an implicit indication of the target node for GHO, as well as (as described above with respect to the information elements of the accumulated measurement report) an indication one or more events that have been triggered. The target node may either be a second infrastructure equipment of the wireless communications network, and the group handover is to be performed by the relay communications device and the one or more of the remote communications devices from a first infrastructure equipment of the wireless communications network to the second infrastructure equipment (GHO scenario 1) or another relay communications device, and the group handover is to be performed by the plurality of the remote communications devices from the relay communications device to the other relay communications device (GHO scenario 2).

The network will then negotiate with the target node, and will send a group handover command to the source relay UE, before GHO is performed as described in the paragraph above, as already discussed in FeD2D group handover. In other words, the relay communications device may be configured to receive, from the wireless communications network in response to the transmitted accumulated measurement report, a group handover command indicating that the group handover is to be performed.

In arrangements of embodiments of the present technique where the group handover procedure is initiated by the target relay UE (for GHO scenario 2), if the target relay UE is configured with measurements towards remote UE and monitors that a group of remote UEs are moving towards it, the potential target relay UE will send an accumulated measurement report to the network. Following this, it is the network's job to identify the source node of these remote UEs and, if they belong to the same source node, to issue a group handover command—to both of the source and target relay UEs.

In the event that the network determines that the GHO is not necessary, despite receipt of the accumulated measurement report from the source relay UE or the target relay UE, it may indicate as such to the source relay UE or the target relay UE. This may be particularly important in the case that the target relay UE initiated the potential handover procedure, as this will allow the target relay UE to release any resources it had reserved for the potential remote UEs that might have handed over to it.

Those skilled in the art would appreciate that the arrangements of embodiments of the present technique described above with respect to target relay UE-initiated group handover procedures, such procedures are also applicable to one or both of the non-accumulated measurement report case and the non-group handover case; i.e. where—in the same manner as described above with respect to group handover and the use of accumulated measurement reports—the target relay UE may initiate, based on measurements performed with respect to a single remote UE/group of remote UEs (without actually generating and transmitting an accumulated measurement report), that that single remote UE/group of remote UEs should handover from the current relay UE to the target relay UE. In other words, the target relay UE may be configured to accumulate one or more measurement reports each indicating measurements of a communications channel between the relay communications device and one of a plurality of remote communications devices, wherein the plurality of remote communications devices are currently connected to the wireless communications network via another relay communications device, to determine, based on the accumulated one or more measurement reports, that one or more of the remote communications devices associated should perform a handover from the other relay communications device to the relay communications device, and to transmit, to an infrastructure equipment of the wireless communications network, an indication that the one or more of the remote communications devices associated should perform a handover from the other relay communications device to the relay communications device.

In some embodiments of the present technique, rather than (or in some cases, in addition to) sending an accumulated measurement report including measurement reports relating to separate remote UEs, a relay UE might transmit a modified version of an existing single measurement report which includes measurements related to all (or at least some of) the remote and/or relay UEs in range of the relay UE, and/or which includes measurements related to the serving gNB and/or other gNBs in range of the relay UE. In other words, the relay UE may be configured to receive reference signals from one or more of the communications devices and/or from one or more infrastructure equipment of the wireless communications network, the one or more communications devices comprising one or more remote communications devices and/or one or more other communications devices acting as relay nodes, to perform measurements on the received reference signals, to generate a measurement report comprising indications of each of the performed measurements, to determine that a trigger condition has been satisfied, and to transmit, to the wireless communications network in response to determining that the trigger condition has been satisfied, the generated measurement report.

Here, such a trigger condition may comprise the relay communications device determining that one or more events (e.g. events A3, A4, or A5 as mentioned previously) have been triggered on the basis of one or more of the performed measurements, and/or a predefined period elapsing since a last measurement report was transmitted by the relay communications device to the wireless communications network (i.e. this modified single measurement report is periodic) or event triggered periodic reporting, and/or at least one of the measurements satisfying one or more predetermined criteria (e.g. a measured RSRP of one of the remote UEs attached to the relay UE, or a measured RSRP of signals received from the gNB might be below a threshold level—though those skilled in the art would appreciate that the measurement type or measured link concerned may be different).

Essentially here, in accordance with such embodiments of the present technique, the relay UE reports sidelink remote/other relay UE measurements when an existing trigger condition (including periodic measurements) is satisfied for the relay UE. That is, the gNB will receive the sidelink remote UE/relay UE measurements when, for example, handover is about to be triggered for the relay UE. Whenever a trigger criteria that is triggered for the relay UE has been met, the relay UE will include the measurements that triggered the report in this single report, but may also include any other measurements it has carried out towards remote UEs or other relay UEs as well in this single report, before transmitting this report to the network. With this measurement report (which is a single report which can include both Uu link and sidelink measurements) will give the network a better view on how to configure or manage handover or group handover—for example, which remote UEs may be handed over along with the relay UE.

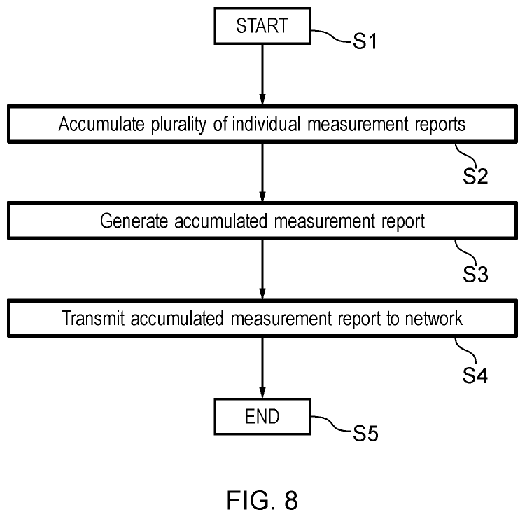

FIG. 8 shows a flow diagram illustrating an example process of communications in a communications system in accordance with embodiments of the present technique. The process shown by FIG. 8 is a method of operating a communications device acting as a relay node configured to transmit signals to and/or to receive signals from a wireless communications network and to transmit signals to and/or to receive signals from a plurality of remote communications devices.

The method begins in step S1. The method comprises, in step S2, accumulating a plurality of measurement reports each indicating measurements of a communications channel between the relay communications device and one of the remote communications devices. In step S3, the process comprises generating an accumulated measurement report comprising indications of a selected one or more of the accumulated plurality of measurement reports. The method then comprises, in step S4, transmitting, to the wireless communications network, the generated accumulated measurement report. The process ends in step S5.

Those skilled in the art would appreciate that the method shown by FIG. 8 may be adapted in accordance with embodiments of the present technique as described herein. For example, other intermediate steps may be included in the method, or the steps may be performed in any logical order. Furthermore, though embodiments of the present technique have been described largely by way of the example system shown in FIG. 7, it would be clear to those skilled in the art that they could be equally applied to other systems than to those described herein.

Those skilled in the art would further appreciate that such wireless communications networks and/or communications devices as herein defined may be further defined in accordance with the various arrangements and embodiments discussed in the preceding paragraphs. It would be further appreciated by those skilled in the art that such wireless communications networks and communications devices as herein defined and described may form part of communications systems other than those defined by the present disclosure.

The following numbered paragraphs provide further example aspects and features of the present technique:
Paragraph 1. A method of operating a communications device acting as a relay node configured to transmit signals to and/or to receive signals from a wireless communications network and to transmit signals to and/or to receive signals from a plurality of remote communications devices, the method comprising
   accumulating a plurality of measurement reports each indicating measurements of a communications channel between the relay communications device and one of the remote communications devices,
   generating an accumulated measurement report comprising indications of a selected one or more of the accumulated plurality of measurement reports, and
   transmitting, to the wireless communications network, the generated accumulated measurement report.
Paragraph 2. A method according to Paragraph 1, comprising
   selecting the selected one or more of the accumulated plurality of measurement reports based on determining that the remote communications devices associated with the selected one or more of the accumulated plurality of measurement reports should perform a group handover with the relay communications device from a first infrastructure equipment of the wireless communications network to a second infrastructure equipment of the wireless communications network.
Paragraph 3. A method according to Paragraph 1 or Paragraph 2, comprising
   selecting the selected one or more of the accumulated plurality of measurement reports based on determining that the remote communications devices associated with the selected one or more of the accumulated plurality of measurement reports should perform a group handover from the relay communications device to another relay communications device.
Paragraph 4. A method according to any of Paragraphs 1 to 3, wherein the accumulated measurement report comprises indications of one or more of:
   identifiers associated with each of the remote communications devices associated with the selected one or more of the accumulated plurality of measurement reports,
   the number of remote communications devices associated with the selected one or more of the accumulated plurality of measurement reports,
   the measurements of each of the selected one or more of the accumulated plurality of measurement reports, and
   one or more events that have been triggered on the basis of the measurements.
Paragraph 5. A method according to Paragraph 4, comprising
   receiving, from the wireless communications network in response to the transmitted accumulated measurement report, a group handover command indicating that a group handover is to be performed to a specified target node.
Paragraph 6. A method according to Paragraph 5, wherein the target node is another relay communications device, and the group handover is to be performed by a plurality of the remote communications devices from the relay communications device to the other relay communications device.
Paragraph 7. A method according to Paragraph 5 or Paragraph 6, wherein the target node is a second infrastructure equipment of the wireless communications network, and the group handover is to be performed by the relay communications device and one or more of the remote communications devices from a first infrastructure equipment of the wireless communications network to the second infrastructure equipment.
Paragraph 8. A method according to any of Paragraphs 1 to 7, comprising
   transmitting reference signals to the remote communications devices, and
   receiving the measurement reports from the remote communications devices, the measurements indicated by the measurement reports having been performed by the remote communications devices on the transmitted reference signals.
Paragraph 9. A method according to Paragraph 8, wherein the selected one or more of the accumulated plurality of measurements reports are those received from the remote communications devices during a predetermined period.
Paragraph 10. A method according to Paragraph 9, comprising
   transmitting the generated accumulated measurement report to the wireless communications network only if the number of the selected one or more of the accumulated plurality of measurements reports received from the remote communications devices during the predetermined period is above a predefined threshold number.
Paragraph 11. A method according to any of Paragraphs 1 to 10, comprising
   receiving reference signals from the remote communications devices, and
   performing the measurements on the received reference signals to generate the plurality of measurement reports.
Paragraph 12. A method according to Paragraph 11, wherein each of the received reference signals comprises an indication of an identifier associated with the remote communications device from which it was received.
Paragraph 13. A method according to Paragraph 12, comprising
   transmitting, to another relay communications device via an infrastructure equipment of the wireless communications network, an indication of identifiers associated with the remote communications devices associated with the selected one or more of the accumulated measurement reports, the other relay device being a target for a group handover to be performed by the remote communications devices associated with the selected one or more of the accumulated measurement reports from the relay communications device to the other relay communications device.
Paragraph 14. A method according to any of Paragraphs 1 to 13, comprising
   transmitting, to another relay communications device via an infrastructure equipment of the wireless communications network, an indication of identifiers associated with one or more of the plurality of remote communications devices.
Paragraph 15. A method according to Paragraph 13 or Paragraph 14, wherein the other relay communications device is within a same cell of the wireless communications network as the relay communications device.
Paragraph 16. A method according to Paragraph 13 or Paragraph 14, wherein the other relay communications device is within a different cell of the wireless communications network to the relay communications device.
Paragraph 17. A communications device acting as a relay node comprising
   transceiver circuitry configured to transmit signals to and/or to receive signals from a wireless communications network and to transmit signals to and/or to receive signals from a plurality of remote communications devices, and
   controller circuitry configured in combination with the transceiver circuitry
   to accumulate a plurality of measurement reports each indicating measurements of a communications channel between the relay communications device and one of the remote communications devices,
   to generate an accumulated measurement report comprising indications of a selected one or more of the accumulated plurality of measurement reports, and
   to transmit, to the wireless communications network, the generated accumulated measurement report.
Paragraph 18. Circuitry for a communications device acting as a relay node, the circuitry comprising
   transceiver circuitry configured to transmit signals to and/or to receive signals from a wireless communications network and to transmit signals to and/or to receive signals from a plurality of remote communications devices, and
   controller circuitry configured in combination with the transceiver circuitry
   to accumulate a plurality of measurement reports each indicating measurements of a communications channel between the relay communications device and one of the remote communications devices,
   to generate an accumulated measurement report comprising indications of a selected one or more of the accumulated plurality of measurement reports, and
   to transmit, to the wireless communications network, the generated accumulated measurement report.
Paragraph 19. A method of operating an infrastructure equipment forming part of a wireless communications network configured to transmit signals to and/or to receive signals from a communications device acting as a relay node for relaying signals between the infrastructure equipment and a plurality of remote communications devices, the method comprising
   receiving, from the relay communications device, an accumulated measurement report comprising indications of a selected one or more of an accumulated plurality of measurement reports, the accumulated plurality of measurement reports each indicating measurements of a communications channel between the relay communications device and one of the remote communications devices.
Paragraph 20. A method according to Paragraph 19, wherein the accumulated measurement report comprises indications of one or more of:
   identifiers associated with each of the remote communications devices associated with the selected one or more of the accumulated plurality of measurement reports,
   the number of remote communications devices associated with the selected one or more of the accumulated plurality of measurement reports,
   the measurements of each of the selected one or more of the accumulated plurality of measurement reports, and
   one or more events that have been triggered on the basis of the accumulated measurement report.
Paragraph 21. A method according to Paragraph 20, comprising
   transmitting, to the relay communications device in response to the received accumulated measurement report, a group handover command indicating that a group handover is to be performed to a specified target node.
Paragraph 22. A method according to Paragraph 21, wherein the target node is another relay communications device, and the group handover is to be performed by a plurality of the remote communications devices from the relay communications device to the other relay communications device.
Paragraph 23. A method according to Paragraph 21 or Paragraph 22, wherein the target node is a second infrastructure equipment of the wireless communications network, and the group handover is to be performed by the relay communications device and one or more of the remote communications devices from the infrastructure equipment to the second infrastructure equipment.
Paragraph 24. A method according to any of Paragraphs 20 to 23, comprising
   transmitting, to the relay communications device in response to the received accumulated measurement report, a group handover command indicating that a group handover is to be performed from another relay communications device to the relay communications device.
Paragraph 25. A method according to any of Paragraphs 20 to 24, comprising
   transmitting, to another relay communications device in response to the received accumulated measurement report, a group handover command indicating that the group handover is to be performed from the other relay communications device to the relay communications device.
Paragraph 26. An infrastructure equipment forming part of a wireless communications network comprising
   transceiver circuitry configured to transmit signals to and/or to receive signals from a communications device acting as a relay node for relaying signals between the infrastructure equipment and a plurality of remote communications devices, and
   controller circuitry configured in combination with the transceiver circuitry
   to receive, from the relay communications device, an accumulated measurement report comprising indications of a selected one or more of an accumulated plurality of measurement reports, the accumulated plurality of measurement reports each indicating measurements of a communications channel between the relay communications device and one of the remote communications devices.
Paragraph 27. Circuitry for an infrastructure equipment forming part of a wireless communications network, the circuitry comprising
   transceiver circuitry configured to transmit signals to and/or to receive signals from a communications device acting as a relay node for relaying signals between the infrastructure equipment and a plurality of remote communications devices, and
   controller circuitry configured in combination with the transceiver circuitry
   to receive, from the relay communications device, an accumulated measurement report comprising indications of a selected one or more of an accumulated plurality of measurement reports, the accumulated plurality of measurement reports each indicating measurements of a communications channel between the relay communications device and one of the remote communications devices.
Paragraph 28. A method of operating a communications device acting as a relay node configured to transmit signals to and/or to receive signals from a wireless communications network, the method comprising
   accumulating one or more measurement reports each indicating measurements of a communications channel between the relay communications device and one of a plurality of remote communications devices, wherein the plurality of remote communications devices are currently connected to the wireless communications network via another relay communications device,
   generating an accumulated measurement report comprising indications of a selected one or more of the accumulated one or more measurement reports, and
   transmitting, to the wireless communications network, the generated accumulated measurement report.
Paragraph 29. A method according to Paragraph 28, comprising
   selecting the selected one or more of the accumulated one or more measurement reports based on determining that the remote communications devices associated with the selected one or more of the accumulated one or more measurement reports should perform a group handover from the other relay communications device to the relay communications device.
Paragraph 30. A method according to Paragraph 28 or Paragraph 29, wherein the accumulated measurement report comprises indications of one or more of:
   identifiers associated with each of the remote communications devices associated with the selected one or more of the accumulated one or more measurement reports,
   the number of remote communications devices associated with the selected one or more of the accumulated one or more measurement reports,
   the measurements of each of the selected one or more of the accumulated one or more measurement reports, and
   one or more events that have been triggered on the basis of the accumulated measurement report.
Paragraph 31. A method according to Paragraph 30, comprising
   receiving, from the wireless communications network in response to the transmitted accumulated measurement report, a group handover command indicating that a group handover is to be performed from the other relay communications device to the relay communications device.
Paragraph 32. A communications device acting as a relay node comprising
   transceiver circuitry configured to transmit signals to and/or to receive signals from a wireless communications network, and
   controller circuitry configured in combination with the transceiver circuitry
   to accumulate one or more measurement reports each indicating measurements of a communications channel between the relay communications device and one of a plurality of remote communications devices, wherein the plurality of remote communications devices are currently connected to the wireless communications network via another relay communications device,
   to generate an accumulated measurement report comprising indications of a selected one or more of the accumulated one or more measurement reports, and
   to transmit, to the wireless communications network, the generated accumulated measurement report.
Paragraph 33. Circuitry for a communications device acting as a relay node, the circuitry comprising
   transceiver circuitry configured to transmit signals to and/or to receive signals from a wireless communications network, and
   controller circuitry configured in combination with the transceiver circuitry
   to accumulate one or more measurement reports each indicating measurements of a communications channel between the relay communications device and one of a plurality of remote communications devices, wherein the plurality of remote communications devices are currently connected to the wireless communications network via another relay communications device,
   to generate an accumulated measurement report comprising indications of a selected one or more of the accumulated one or more measurement reports, and
   to transmit, to the wireless communications network, the generated accumulated measurement report.
Paragraph 34. A method of operating a communications device acting as a relay node configured to transmit signals to and/or to receive signals from a wireless communications network, the method comprising
   accumulating one or more measurement reports each indicating measurements of a communications channel between the relay communications device and one of a plurality of remote communications devices, wherein the plurality of remote communications devices are currently connected to the wireless communications network via another relay communications device,
   determining, based on the accumulated one or more measurement reports, that one or more of the remote communications devices associated should perform a handover from the other relay communications device to the relay communications device, and
   transmitting, to an infrastructure equipment of the wireless communications network, an indication that the one or more of the remote communications devices associated should perform a handover from the other relay communications device to the relay communications device.
Paragraph 35. A communications device acting as a relay node comprising
   transceiver circuitry configured to transmit signals to and/or to receive signals from a wireless communications network, and
   controller circuitry configured in combination with the transceiver circuitry
   to accumulate one or more measurement reports each indicating measurements of a communications channel between the relay communications device and one of a plurality of remote communications devices, wherein the plurality of remote communications devices are currently connected to the wireless communications network via another relay communications device,
   to determine, based on the accumulated one or more measurement reports, that one or more of the remote communications devices associated should perform a handover from the other relay communications device to the relay communications device, and
   to transmit, to an infrastructure equipment of the wireless communications network, an indication that the one or more of the remote communications devices associated should perform a handover from the other relay communications device to the relay communications device.
Paragraph 36. Circuitry for a communications device acting as a relay node, the circuitry comprising
   transceiver circuitry configured to transmit signals to and/or to receive signals from a wireless communications network, and
   controller circuitry configured in combination with the transceiver circuitry
   to accumulate one or more measurement reports each indicating measurements of a communications channel between the relay communications device and one of a plurality of remote communications devices, wherein the plurality of remote communications devices are currently connected to the wireless communications network via another relay communications device,
   to determine, based on the accumulated one or more measurement reports, that one or more of the remote communications devices associated should perform a handover from the other relay communications device to the relay communications device, and
   to transmit, to an infrastructure equipment of the wireless communications network, an indication that the one or more of the remote communications devices associated should perform a handover from the other relay communications device to the relay communications device.
Paragraph 37. A method of operating a communications device acting as a relay node configured to transmit signals to and/or to receive signals from a wireless communications network and to transmit signals to and/or to receive signals from a plurality of communications devices, the method comprising
   receiving reference signals from one or more of the communications devices and/or from one or more infrastructure equipment of the wireless communications network, the one or more communications devices comprising one or more remote communications devices and/or one or more other communications devices acting as relay nodes,
   performing measurements on the received reference signals,
   generating a measurement report comprising indications of each of the performed measurements,
   determining that a trigger condition has been satisfied, and
   transmitting, to the wireless communications network in response to determining that the trigger condition has been satisfied, the generated measurement report.
Paragraph 38. A method according to Paragraph 37, wherein the trigger condition comprises the relay communications device determining that one or more events have been triggered on the basis of one or more of the performed measurements.
Paragraph 39. A method according to Paragraph 37 or Paragraph 38, wherein the trigger condition comprises a predefined period elapsing since a last measurement report was transmitted by the relay communications device to the wireless communications network.
Paragraph 40. A method according to any of Paragraphs 37 to 39, wherein the trigger condition comprises at least one of the measurements satisfying one or more predetermined criteria.
Paragraph 41. A communications device acting as a relay node comprising
   transceiver circuitry configured to transmit signals to and/or to receive signals from a wireless communications network, and
   controller circuitry configured in combination with the transceiver circuitry
   to receive reference signals from one or more of the communications devices and/or from one or more infrastructure equipment of the wireless communications network, the one or more communications devices comprising one or more remote communications devices and/or one or more other communications devices acting as relay nodes,
   to perform measurements on the received reference signals,
   to generate a measurement report comprising indications of each of the performed measurements,
   to determine that a trigger condition has been satisfied, and
   to transmit, to the wireless communications network in response to determining that the trigger condition has been satisfied, the generated measurement report.
Paragraph 42. Circuitry for a communications device acting as a relay node, the circuitry comprising
   transceiver circuitry configured to transmit signals to and/or to receive signals from a wireless communications network, and
   controller circuitry configured in combination with the transceiver circuitry
   to receive reference signals from one or more of the communications devices and/or from one or more infrastructure equipment of the wireless communications network, the one or more communications devices comprising one or more remote communications devices and/or one or more other communications devices acting as relay nodes,
   to perform measurements on the received reference signals,
   to generate a measurement report comprising indications of each of the performed measurements,
   to determine that a trigger condition has been satisfied, and
   to transmit, to the wireless communications network in response to determining that the trigger condition has been satisfied, the generated measurement report.
Paragraph 43. A wireless communications system comprising at least one of a communications device acting as a relay device according to Paragraph 17, a communications device acting as a relay device according to Paragraph 32, a communications device acting as a relay device according to Paragraph 35, a communications device acting as a relay device according to Paragraph 41, and an infrastructure equipment according to Paragraph 26.
Paragraph 44. A computer program comprising instructions which, when loaded onto a computer, cause the computer to perform a method according to any of Paragraphs 1 to 16, Paragraphs 19 to 25, Paragraphs 28 to 31, Paragraph 34, or Paragraphs 37 to 40.
Paragraph 45. A non-transitory computer-readable storage medium storing a computer program according to Paragraph 44.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the

### REFERENCES

[1] RP-182090, “Revised SID: Study on NR Industrial Internet of Things (IoT),” 3GPP RAN #81.
[2] Holma H. and Toskala A, “LTE for UMTS OFDMA and SC-FDMA based radio access”, John Wiley and Sons, 2009.
[3] RP-193253, “New SID: Study on NR sidelink relay” (OPPO), December 2019.
[4] TR 36.746, “3^{rd} Generation Partnership Project; Technical Specification Group Radio Access Network; Study on further enhancements to LTE Device to Device (D2D), User Equipment (UE) to network relays for Internet of Things (IoT) and wearables; (Release 15) (version 15.1.1)” (3GPP Organisation), April 2018.
[5] R2-2108939, “Email Report of (AT115-e][609][Relay] Service continuity procedures” (MediaTek Inc.), August 2021.
[6] TS 38.311, “3^{rd} Generation Partnership Project; Technical Specification Group Radio Access Network; NR; Radio Resource Control (RRC) protocol specification (Release 16)” (3GPP Organisation), September 2021.

1. A method of operating a communications device acting as a relay node configured to transmit signals to and/or to receive signals from a wireless communications network and to transmit signals to and/or to receive signals from a plurality of remote communications devices, the method comprising
accumulating a plurality of measurement reports each indicating measurements of a communications channel between the relay communications device and one of the remote communications devices,
generating an accumulated measurement report comprising indications of a selected one or more of the accumulated plurality of measurement reports, and
transmitting, to the wireless communications network, the generated accumulated measurement report.

2. A method according to claim 1, comprising
selecting the selected one or more of the accumulated plurality of measurement reports based on determining that the remote communications devices associated with the selected one or more of the accumulated plurality of measurement reports should perform a group handover with the relay communications device from a first infrastructure equipment of the wireless communications network to a second infrastructure equipment of the wireless communications network.

3. A method according to claim 1, comprising
selecting the selected one or more of the accumulated plurality of measurement reports based on determining that the remote communications devices associated with the selected one or more of the accumulated plurality of measurement reports should perform a group handover from the relay communications device to another relay communications device.

4. A method according to claim 1, wherein the accumulated measurement report comprises indications of one or more of:
identifiers associated with each of the remote communications devices associated with the selected one or more of the accumulated plurality of measurement reports,
the number of remote communications devices associated with the selected one or more of the accumulated plurality of measurement reports,
the measurements of each of the selected one or more of the accumulated plurality of measurement reports, and
one or more events that have been triggered on the basis of the measurements.

5. A method according to claim 4, comprising
receiving, from the wireless communications network in response to the transmitted accumulated measurement report, a group handover command indicating that a group handover is to be performed to a specified target node.

6. A method according to claim 5, wherein the target node is another relay communications device, and the group handover is to be performed by a plurality of the remote communications devices from the relay communications device to the other relay communications device.

7. A method according to claim 5, wherein the target node is a second infrastructure equipment of the wireless communications network, and the group handover is to be performed by the relay communications device and one or more of the remote communications devices from a first infrastructure equipment of the wireless communications network to the second infrastructure equipment.

8. A method according to claim 1, comprising
transmitting reference signals to the remote communications devices, and
receiving the measurement reports from the remote communications devices, the measurements indicated by the measurement reports having been performed by the remote communications devices on the transmitted reference signals.

9. A method according to claim 8, wherein the selected one or more of the accumulated plurality of measurements reports are those received from the remote communications devices during a predetermined period.

10. A method according to claim 9, comprising
transmitting the generated accumulated measurement report to the wireless communications network only if the number of the selected one or more of the accumulated plurality of measurements reports received from the remote communications devices during the predetermined period is above a predefined threshold number.

11. A method according to claim 1, comprising
receiving reference signals from the remote communications devices, and
performing the measurements on the received reference signals to generate the plurality of measurement reports.

12. A method according to claim 11, wherein each of the received reference signals comprises an indication of an identifier associated with the remote communications device from which it was received.

13. A method according to claim 12, comprising
transmitting, to another relay communications device via an infrastructure equipment of the wireless communications network, an indication of identifiers associated with the remote communications devices associated with the selected one or more of the accumulated measurement reports, the other relay device being a target for a group handover to be performed by the remote communications devices associated with the selected one or more of the accumulated measurement reports from the relay communications device to the other relay communications device.

14. A method according to claim 1, comprising
transmitting, to another relay communications device via an infrastructure equipment of the wireless communications network, an indication of identifiers associated with one or more of the plurality of remote communications devices.

15. A method according to claim 13, wherein the other relay communications device is within a same cell of the wireless communications network as the relay communications device.

16. A method according to claim 13, wherein the other relay communications device is within a different cell of the wireless communications network to the relay communications device.

17. A communications device acting as a relay node comprising
transceiver circuitry configured to transmit signals to and/or to receive signals from a wireless communications network and to transmit signals to and/or to receive signals from a plurality of remote communications devices, and
controller circuitry configured in combination with the transceiver circuitry
to accumulate a plurality of measurement reports each indicating measurements of a communications channel between the relay communications device and one of the remote communications devices,
to generate an accumulated measurement report comprising indications of a selected one or more of the accumulated plurality of measurement reports, and
to transmit, to the wireless communications network, the generated accumulated measurement report.

18.-25. (canceled)

26. An infrastructure equipment forming part of a wireless communications network comprising
transceiver circuitry configured to transmit signals to and/or to receive signals from a communications device acting as a relay node for relaying signals between the infrastructure equipment and a plurality of remote communications devices, and
controller circuitry configured in combination with the transceiver circuitry
to receive, from the relay communications device, an accumulated measurement report comprising indications of a selected one or more of an accumulated plurality of measurement reports, the accumulated plurality of measurement reports each indicating measurements of a communications channel between the relay communications device and one of the remote communications devices.

27.-45. (canceled)
